(19) United States
(12) Patent Application Publication
(10) Pub. No.: US 2013/0119671 A1
(43) Pub. Date: May 16, 2013

(54) SCREW EXPANSION POWER GENERATION DEVICE

(71) Applicant: Yan Tang, Shanghai (CN)

(72) Inventor: Yan Tang, Shanghai (CN)

(73) Assignee: SHANGHAI POWER TECH. SCREW MACHINERY CO., LTD., Shanghai (CN)

(21) Appl. No.: 13/812,845

(22) PCT Filed: Nov. 30, 2010
(86) PCT No.: PCT/CN2010/079285

§ 371 Date: Jan. 28, 2013

(30) Foreign Application Priority Data
Nov. 16, 2010 (CN) 201010548665.8

(51) Int. Cl. H02K 57/00

(52) U.S. Cl. CPC H02K 57/003
USPC 290/54

(57) ABSTRACT

A screw expansion power generation device is disclosed, applicable to an Organic Rankin Cycle (ORC). The power generation device includes a semi-sealed or fully sealed shell. The shell includes an expander cavity and a generator cavity. The expander cavity is not in communication with the generator cavity. A screw expander is disposed in the expander cavity, and a generator is disposed in the generator cavity. A rotor of the screw expander is fixedly connected to a rotor of the generator. The power generation device drives the generator to generate power through rotation of the rotor of the screw expander. A liquid refrigerant injection inlet and a refrigerant outlet are disposed on the generator cavity. The generator is cooled through evaporation of a liquid refrigerant. The screw expansion power generation device of the present invention is semi-sealed or fully sealed. The screw expander and the generator are disposed in the shell as a whole. The generator may be a synchronous generator or an asynchronous generator, thereby preventing leakage of the refrigerant when the screw expansion generator generates power.

### BACKGROUND OF THE PRESENT INVENTION

1. Field of Invention

The present invention relates to the field of power generation equipment technology, specifically to an Organic Rankin Cycle (ORC) power generation system, and meanwhile to a semi-sealed or fully sealed screw expansion power generation device.

2. Description of Related Arts

Referring to FIG. 1, FIG. 1 is a typical ORC, which includes an expander 1′, a generator 2′, an evaporator 3′, a liquid pump 4′ and a condenser 5′.

A low-temperature and low-pressure liquid refrigerant is pressurized in the liquid pump 4′, and then enters the evaporator 3′ to be evaporated through heating until the refrigerant becomes an overheated gas (high temperature and high pressure). The overheated gas enters the expander 1′ to work through expansion, so as to drive the generator 2′ to generate power. After working, the low-temperature and low-pressure gas enters the condenser 5′ and is condensed to liquid, and then flows back into the liquid pump 4′, thus completing a cycle.

Existing expanders used in the ORC are semi-sealed centrifugal expanders and open-type screw expanders. The open-type screw expander is connected to a generator at an output shaft end through a shaft seal, and a defect thereof is that a refrigerant will leak through the shaft seal.

Meanwhile, in a cascade ORC cycle (or other application scenarios), a temperature at the end of the expansion may be very high, so cooling the generator by exhaust of the expansion becomes impractical. A cooling problem of the generator in the semi-sealed or fully sealed screw expansion power generation device needs to be solved.

### SUMMARY OF THE PRESENT INVENTION

The technical problem to be solved in the present invention is to provide a semi-sealed or fully sealed screw expansion power generation device, which can prevent leakage of a refrigerant when a screw expansion generator generates power, and at the same time can cool the generator in the screw expansion power generation device.

In order to solve the above technical problem, the present invention adopts the following technical solution.

A semi-sealed or fully sealed screw expansion power generation device is provided, wherein the power generation device comprises a semi-sealed or fully sealed shell, the shell comprises an expander cavity and a generator cavity; the expander cavity is not in communication with the generator cavity; a screw expander is disposed in the expander cavity, and a generator is disposed in the generator cavity; a rotor of the screw expander is fixedly connected to a rotor of the generator; the power generation device drives the generator to generate power through rotation of the rotor of the screw expander; a liquid refrigerant injection inlet and a refrigerant outlet are disposed on the generator cavity; and the generator is cooled through evaporation of the liquid refrigerant.

As a preferential solution of the present invention, the screw expander comprises a male rotor and a female rotor, and a shaft of the male rotor is fixedly connected to the rotor of the generator.

As a preferential solution of the present invention, a first male rotor bearing is disposed at an end of the male rotor away from the rotor of the generator, and female rotor bearings are separately disposed at two ends of the female rotor.

As a preferential solution of the present invention, the male rotor comprises a rotor part and a connection part which are integrally designed, and the rotor part coordinates with the female rotor; the connection part extends into the generator; the expander cavity and the generator cavity are isolated from each other through an isolation mechanism, so that a hole is formed between the expander cavity and the generator cavity; the connection part passes through the hole and enters the generator cavity, and an end of the connection part away from the rotor part is fixedly connected to the rotor of the generator.

As a preferential solution of the present invention, a second male rotor bearing is disposed at the connection part and between the rotor part of the male rotor and the rotor of the generator; the first male rotor bearing, the second male rotor bearing and the female rotor bearings are separately disposed in the shell through a support mechanism disposed in the shell; the connection part and an end of the second male rotor bearing closest to the rotor of the generator are sealed through a shaft seal.

As a preferential solution of the present invention, a suction inlet and an exhaust outlet of the screw expander are disposed on the expander cavity.

As a preferential solution of the present invention, the generator is a synchronous generator or an asynchronous generator.

The present invention has the following beneficial effects: the semi-sealed or fully sealed screw expansion power generation device and the ORC power generation system using the screw expansion power generation device provided in the present invention can prevent the refrigerant from leaking through the shaft seal when the screw expansion generator generates power. Meanwhile, the generator can be effectively cooled. The cooling problem of the generator in the screw expansion power generation device can be solved even in a cascade ORC cycle or in a single cycle where the exhaust of the expander is of a very high temperature.

### BRIEF DESCRIPTION OF THE DRAWINGS

FIG. 1 is a schematic view of composition of an ORC power generation system.

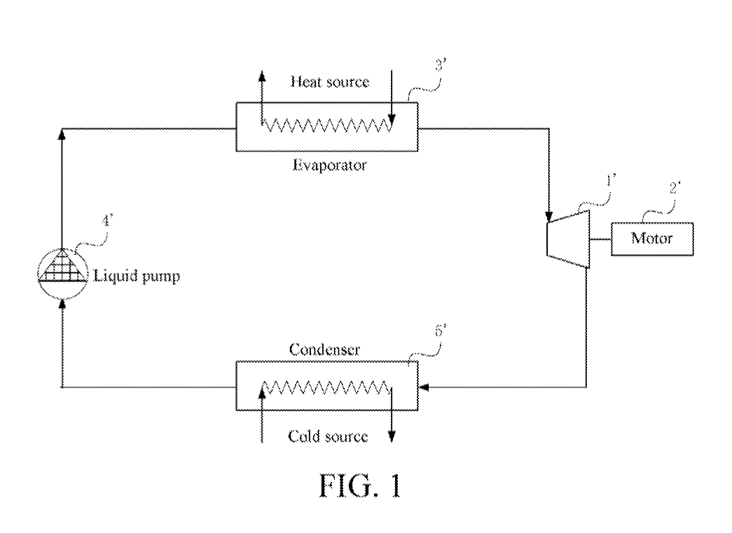

FIG. 2 is a schematic view of composition of an ORC power generation system consistent with the present invention.

FIG. 3 is a sectional view of a screw expansion power generation device in a vertical direction consistent with the present invention.

FIG. 4 is a sectional view of a screw expansion power generation device in a horizontal direction consistent with the present invention.

### LIST OF REFERENCE NUMERALS

1′ Expander
2 Generator
3′ Evaporator
4′ Liquid pump
5′ Condenser
1 Screw expansion power generation device
3 Evaporator
4 Liquid pump
5 Condenser
101 Generator
102 Male rotor
103 Female rotor
1041 First male rotor bearing
1042 Second male rotor bearing
105 Female rotor bearing
106 Seal ring
107 Suction inlet
108 Exhaust outlet
109 Refrigerant injection inlet
110 Refrigerant outlet
111 Shaft seal

### DETAILED DESCRIPTION OF THE PREFERRED EMBODIMENTS

Exemplary embodiments of the present invention are described in detail with reference to the accompanying drawings below.

### Embodiment 1

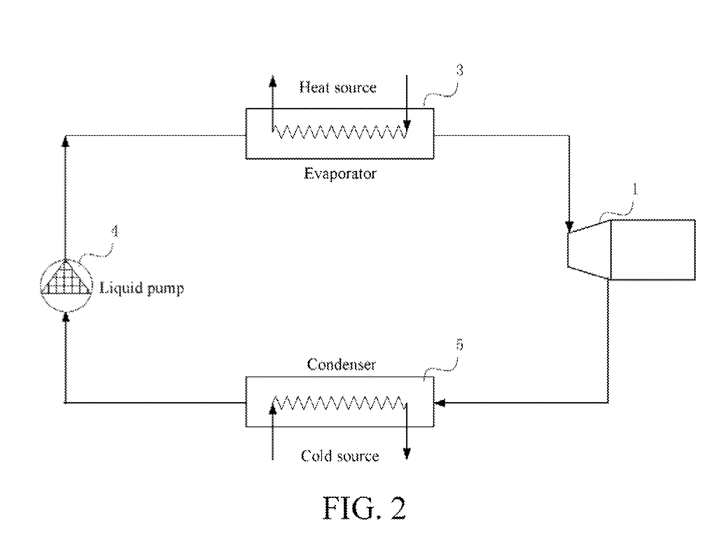

Referring to FIG. 2, FIG. 2 depicts an ORC power generation system using the present invention. The ORC power generation system includes a condenser 5, a liquid pump 4, an evaporator 3, and a screw expansion power generation device 1 connected in order. The screw expansion power generation device 1 disclosed in the present invention includes a semi-sealed or fully sealed screw expander and a generator which are integrally disposed. The generator may be a synchronous generator or an asynchronous generator.

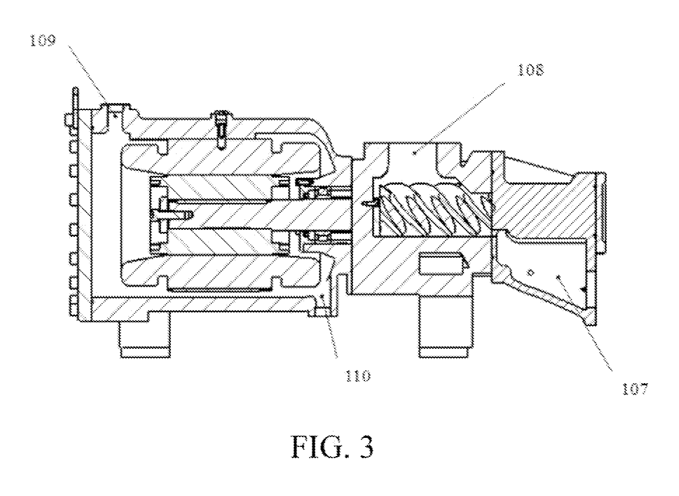

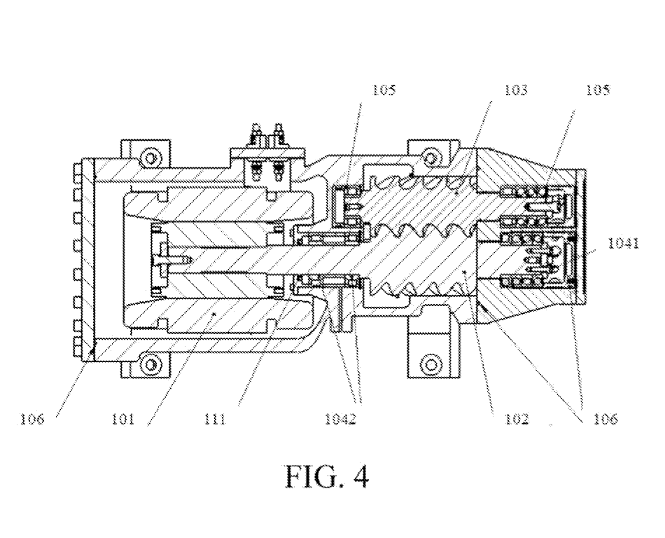

Referring to FIG. 3 and FIG. 4, the power generation device 1 includes a semi-sealed or fully sealed shell. The shell includes an expander cavity and a generator cavity. The expander cavity and the generator cavity are not in communication and are isolated from each other. A screw expander is disposed in the expander cavity, and a generator 101 is disposed in the generator cavity. A liquid refrigerant injection inlet 109 and a refrigerant outlet 110 are disposed on the generator cavity. The generator 101 is cooled through evaporation of the liquid refrigerant. A suction inlet 107 and an exhaust outlet 108 of the screw expander are disposed on the expander cavity. The shell is formed of multiple components, and in order to improve the seal effect, a seal ring 106 is disposed between subdivision surfaces.

The screw expander and the generator 101 are integrally disposed. A rotor of the screw expander is fixedly connected to a rotor of the generator, and the power generation device 1 drives the generator 101 to generate power through rotation of the rotor of the screw expander.

Further referring to FIG. 4, in this embodiment, the screw expander includes a male rotor 102, and a female rotor 103. A shaft of the male rotor 102 is fixedly connected to the rotor of the generator 101. Female rotor bearings 105 are separately disposed on two ends of the female rotor 103. A first male rotor bearing 1041 is disposed at an end of the male rotor 102 away from the rotor of the generator. The male rotor 102 includes a rotor part and a connection part which are integrally designed. The rotor part coordinates with the female rotor 103, and the connection part extends into the generator 101. The expander cavity and the generator cavity are isolated from each other through an isolation mechanism, so that a hole is formed between the expander cavity and the generator cavity. The connection part passes through the hole and enters the generator cavity. An end of the connection part away from the rotor part is fixedly connected to the rotor of the generator. A second male rotor bearing 1042 is disposed at the connection part and between the rotor part of the male rotor and the rotor of the generator. The connection part and an end of the second male rotor bearing 1042 closest to the rotor of the generator are sealed through a shaft seal 111. The first male rotor bearing 1041, the second male rotor bearing 1042, and the female rotor bearings 105 are separately disposed in the shell through a support mechanism disposed in the shell.

In conclusion, in the semi-sealed or fully sealed screw expansion power generation device and the ORC power generation system using the above screw expansion power generation device provided in the present invention, the screw expansion power generation device is semi-sealed or fully sealed; the screw expander and the generator are disposed in the shell as a whole, thereby preventing leakage of the refrigerant through the shaft seal when the screw expansion generator generates power. Meanwhile, the generator can be cooled effectively. Even in a cascade ORC, or even when an exhaust temperature of the expander is very high in a single cycle, the cooling problem of the generator in the screw expansion power generation device can be solved.

### Embodiment 2

In this embodiment, a rotor that drives the generator to generate power may be a female rotor.

Herein, the description and application of the present invention are illustrative, and the scope of the present invention is not intended to be limited to the above embodiments. Variations and changes to the embodiments disclosed herein are possible. Replacement made to the embodiments and equivalent parts are well-known to persons skilled in the art. It should be known to persons skilled in the art that, the present invention can be implemented in other forms, structures, arrangements, ratios and through other components, materials, and parts without departing from the script or essential features of the present invention. Other variations and changes may be made to the embodiments disclosed herein without departing from the scope and script of the present invention.

What is claimed is:

1. A screw expansion power generation device, wherein the power generation device comprises a semi-sealed or fully sealed shell, the shell comprises an expander cavity and a generator cavity; the expander cavity is not in communication with the generator cavity; a screw expander is disposed in the expander cavity, and a generator is disposed in the generator cavity;
a rotor of the screw expander is fixedly connected to a rotor of the generator; the power generation device drives the generator to generate power through rotation of the rotor of the screw expander; and
a liquid refrigerant injection inlet and a refrigerant outlet are disposed on the generator cavity; and the generator is cooled through evaporation of a liquid refrigerant.

2. The screw expansion power generation device as in claim 1, wherein
the screw expander comprises a male rotor and a female rotor, and a shaft of the male rotor is fixedly connected to the rotor of the generator.

3. The screw expansion power generation device as in claim 2, wherein
a first male rotor bearing is disposed at an end of the male rotor away from the rotor of the generator, and female rotor bearings are separately disposed at two ends of the female rotor.

4. The screw expansion power generation device as in claim 3, wherein
the male rotor comprises a rotor part and a connection part which are integrally designed, and the rotor part coordinates with the female rotor; the connection part extends into the generator; and
the expander cavity and the generator cavity are isolated from each other through an isolation mechanism, so that a hole is formed between the expander cavity and the generator cavity; the connection part passes through the hole and enters the generator cavity, and an end of the connection part away from the rotor part is fixedly connected to the rotor of the generator.

5. The screw expansion power generation device as in claim 4, wherein
a second male rotor bearing is disposed at the connection part and between the rotor part of the male rotor and the rotor of the generator.

6. The screw expansion power generation device as in claim 5, wherein
the connection part and an end of the second male rotor bearing close to the rotor of the generator are sealed through a shaft seal.

7. The screw expansion power generation device as in claim 1, wherein
a suction inlet and an exhaust outlet of the screw expander are disposed at the expander cavity.

8. A screw expansion power generation device, wherein the power generation device is applied to an Organic Rankin Cycle (ORC);
the power generation device comprises a semi-sealed or fully sealed shell, the shell comprises an expander cavity and a generator cavity; the expander cavity is not in communication with the generator cavity; a screw expander is disposed in the expander cavity, and a generator is disposed in the generator cavity;
a rotor of the screw expander is fixedly connected to a rotor of the generator; the power generation device drives the generator to generate power through rotation of the rotor of the screw expander;
a liquid refrigerant injection inlet and a refrigerant outlet are disposed on the generator cavity; and the generator is cooled through evaporation of a liquid refrigerant;
the screw expander comprises a male rotor and a female rotor, and a shaft of the male rotor is fixedly connected to the rotor of the generator;
a first male rotor bearing is disposed at an end of the male rotor away from the rotor of the generator; female rotor bearings are separately disposed at two ends of the female rotor; the male rotor comprises a rotor part and a connection part which are integrally designed; the rotor part coordinates with the female rotor, and the connection part extends into the generator;
the expander cavity and the generator cavity are isolated from each other through an isolation mechanism, so that a hole is formed between the expander cavity and the generator cavity; the connection part passes through the hole and enters the generator cavity, and an end of the connection part away from the rotor part is fixedly connected to the rotor of the generator;
a second male rotor bearing is disposed at the connection part and between the rotor part of the male rotor and the rotor of the generator; the connection part and an end of the second male rotor bearing closest to the rotor of the generator are sealed through a shaft seal;
a suction inlet and an exhaust outlet of the screw expander are disposed at the expander cavity; and
the generator is a synchronous generator or an asynchronous generator.
